(19) United States
(12) Patent Application Publication
(10) Pub. No.: US 2010/0052604 A1
(43) Pub. Date: Mar. 4, 2010

(54) REMOVABLE POWER STORAGE DEVICE

(76) Inventor: Tao-Heng Sun, Taipei City (TW)

Correspondence Address: Muncy, Geissler, Olds & Lowe, PLLC, P.O. BOX 1364, FAIRFAX, VA, 22038-1364, US

(21) Appl. No.: 12/204,591

(22) Filed: Sep. 4, 2008

(51) Int. Cl. H02J 7/32

(52) U.S. Cl. 320/101

(57) ABSTRACT

A removable power storage device includes at least one airflow pressure differential power generating assembly and a power storage assembly. The airflow pressure differential power generating assembly is driven by energy created by surrounding airflow pressure differential to generate electric power. The generated power is stored in at least one removable power storage unit of the power storage assembly for use later in different places.

### FIELD OF THE INVENTION

The present invention relates to a power storage device, and more particularly to a removable power storage device that utilizes airflow pressure differential to drive a power generating assembly to generate electric power and stores the generated electric power in a plurality of removable power storage units of a power storage assembly.

### BACKGROUND OF THE INVENTION

It is known that the atmospheric pressure surrounding our living environment is usually stable. However, when there is a difference between the atmospheric pressure of two locations, air current or wind is created. The extensity of wind varies with the magnitude of the pressure difference. The larger the magnitude of the pressure difference is, the higher the energy can be provided by the wind. For instance, in the nature, there are air currents having different intensities to present as breeze, hurricane, typhoon, etc. And, there are also man-made airflows created by means of electric fans, cooling fans, radiating fans, etc. The natural wind or man-made airflows provide wind energy that will never be depleted. It would be a pity if the rich wind energy is not well utilized.

Many kinds of wind power generating devices and wind power storage systems have been developed. All these wind power generating devices and wind power storage systems have a common disadvantage that they have a power storage unit and a power generating unit that are inseparable from one another. Under such circumstance, the power storage unit is not freely removable. When it is desired to use the stored power at a remote location, at least one cable extended from the power storage unit to the remote location is needed to transmit the stored power. Moreover, since the power storage unit is not freely removable, the power stored therein can only be used at a place at where the power storage unit is located. As a result, the stored power storage has low utilization efficiency.

It is therefore tried by the inventor to develop a removable power storage device having separable and portable power storage units to enable high-efficient utilization of the stored power.

The utilization of wind energy and the use of removable power storage units for storing wind energy are two important issues in terms of environmental protection.

### SUMMARY OF THE INVENTION

A primary object of the present invention is to provide a removable power storage device, in which at least one airflow pressure differential power generating assembly is driven by energy created by surrounding airflow pressure differential to generate electric power. The generated power is stored in at least one removable power storage unit. The power storage unit with power stored therein can be carried to different places for supplying additional power in different applications.

To achieve the above and other objects, the removable power storage device of the present invention includes at least one airflow pressure differential power generating assembly and a power storage assembly. The airflow pressure differential power generating assembly is driven by wind force created by surrounding airflow pressure differential to generate electric power. The generated power is transmitted to and stored in the removable power storage unit of the power storage assembly. The power storage unit can be independently removed from the power storage assembly for replacement or for use in different places to supply power to other devices.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view showing the removable power storage device of the present invention;

FIG. 2 shows a first application of the removable power storage device of the present invention, in which the removable power storage device is installed on a car;

FIG. 3 shows a second application of the removable power storage device of the present invention, in which the removable power storage device is installed on a cooling water tower;

FIG. 4 shows a third application of the removable power storage device of the present invention, in which the removable power storage device is installed on a window-type air-conditioner; and

FIG. 5 shows a fourth application of the removable power storage device of the present invention, in which the removable power storage device is installed on a motorcycle.

### DETAILED DESCRIPTION OF THE PREFERRED EMBODIMENTS

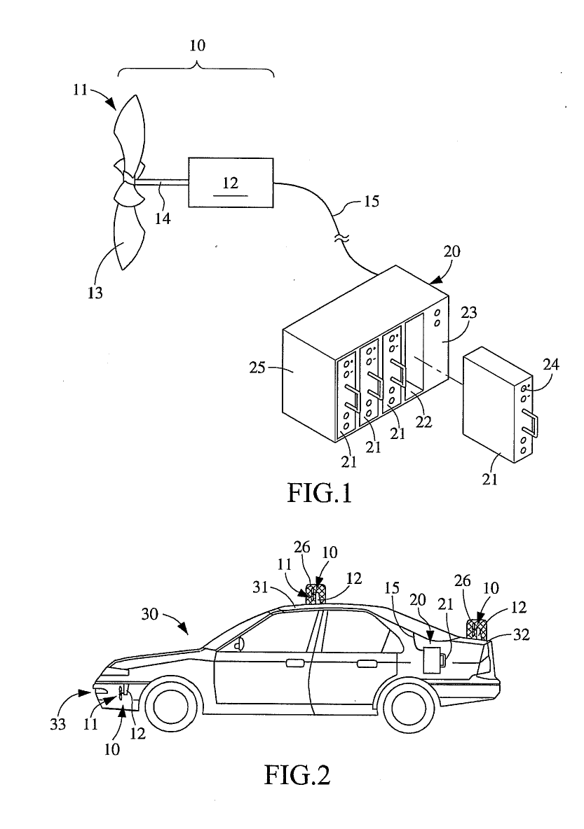

Please refer to FIG. 1 that shows a removable power storage device according to the present invention. As shown, the removable power storage device includes at least one airflow pressure differential power generating assembly 10 and a power storage assembly 20. The airflow pressure differential power generating assembly 10 includes a rotor 11 having a plurality of blades 13 and an induction generator 12. A change in the atmospheric pressure surrounding the airflow pressure differential power generating assembly 10 would create kinetic energy of airflow, which is presented as wind force. The intensity of the wind force is determined by the magnitude of air pressure difference. When the airflow flows through the rotor 11 to push against the blades 13, the rotor 11 is driven by the wind force to rotate. An axle of the rotor 11 is connected to a front end of a link 14. A rear end of the link 14 is connected to the induction generator 12. When the rotor 11 is driven to rotate by the wind force, the induction generator 12 is synchronously driven via the link 14. The induction generator 12 is a magnetic generator including internal magnets and windings (not shown). Due to an interaction between the magnets and the windings, a magnetic line cutting effect is produced to achieve the purpose of power generating.

The power generated by the airflow pressure differential power generating assembly 10 is transmitted to the power storage assembly 20 via a power cable 15. The power storage assembly 20 includes a main body 25 and at least one power storage unit 21. The main body 25 has a plurality of compartments 22, and the power storage unit 21 each is removably installed in one of the compartments 22. The power storage assembly 20 further includes a control circuit unit 23 that is a necessary control circuit for installing the removable power storage device of the present invention. The control circuit unit 23 can be integrated with the main body 25 to form an integral body. Alternatively, the control circuit unit 23 can be removably associated with the main body 25 to enable convenient maintenance and repair thereof. An input terminal of the control circuit unit 23 is connected to the power cable 15 of the airflow pressure differential power generating assembly 10. The control circuit unit 23 is internally provided with various necessary control circuits, including an AC-to-DC converter circuit, a rectifier diode circuit, a stabilizing circuit, an overload protection circuit, a power level indicating circuit, etc., so as to provide stable charging current output and overload protection to the power storage unit 21 installed in each of the compartments 22.

Referring to FIG. 1, the control circuit unit 23 in the illustrated embodiment of the present invention is integrated with the power storage assembly 20 to form an integral body. In practice, the power storage unit 21 can be independently inserted into or removed from one of the compartments 22, and has a power output terminal 24, via which the power stored in the power storage unit 21 can be supplied for use at different conditions. For example, the power storage unit 21 can be used outdoors or in a power failure to supply temporary power. Therefore, the present invention has extended usages.

Airflow pressure differential can be created in many ways. For example, a running car, an operating cooling fan of a cooling water tower of a building, and an operating heat-radiating fan on a rear side of a window-type air-conditioner all can create additional airflows. Please now refer to FIG. 2, which shows a first application of the removable power storage device of the present invention. The removable power storage device can be installed to any site at where airflows are produced, such as on a car. It is known that airflow pressure differential exists at different areas of a running car due to air resistance. That is, when a car is moving, airflows are created surrounding the car. Therefore, the airflow pressure differential power generating assembly 10 can be installed on a roof 31 or a trunk lid 32 of a car 30. A net-like protective cover 26 can be mounted to an outer side of the airflow pressure differential power generating assembly 10 to protect the rotor 11 against damage due to collision with external objects. Alternatively, the airflow pressure differential power generating assembly 10 can be installed on the car 30 at other areas, at where airflows are guided, such as a front spoiler 33 of the car 30, so long as the rotor 11 of the airflow pressure differential power generating assembly 10 can be effectively driven to rotate by wind force. The induction generator 12 is connected to the rotor 11 via the link 14 as having been mentioned above. Therefore, when the rotor 11 is rotated, it brings the induction generator 12 to generate electric current, which is stored in the power storage units 21 for use later.

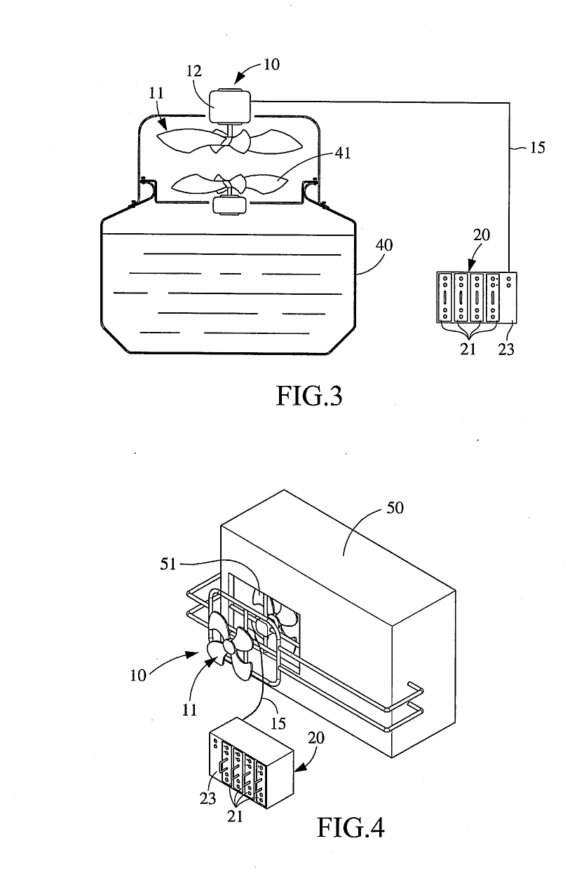

Please refer to FIG. 3, which shows a second application of the removable power storage device of the present invention. In the second application, the wind force for driving the rotor 11 is provided by a large cooling fan 41 of a cooling water tower 40 for a central air-conditioning system of a building. The cooling water tower is built on a roof of the building, and the cooling fan 41 is arranged in the cooling water tower 40. The airflow pressure differential power generating assembly 10 of the removable power storage device of the present invention is installed at an exhaust opening of the cooling water tower 40 above the cooling fan 41. When operating, the cooling fan 41 produces airflows to rotate the rotor 11 of the airflow pressure differential power generating assembly 10. Again, the induction generator 12 connected to the rotor 11 via the link 14 is driven by the rotating rotor 11 to generate electric current, which is stored in the power storage units 21 for use later.

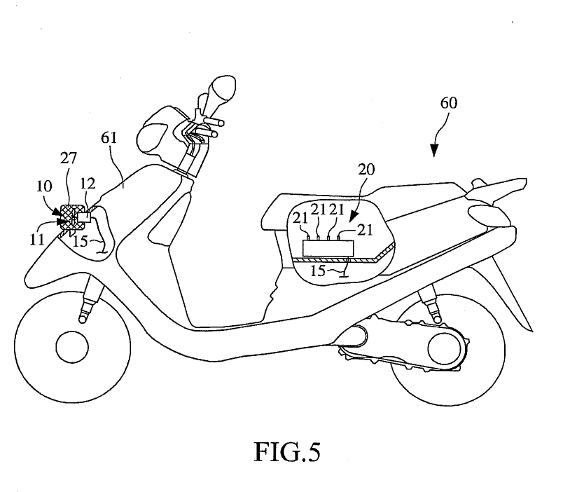

FIG. 4 shows a third application of the removable power storage device of the present invention. In the third application, the wind force for driving the rotor 11 is provided by a heat-radiating fan 51 located at a rear side of a window-type air-conditioner 50. The airflow pressure differential power generating assembly 10 of the removable power storage device of the present invention is installed at an exhaust opening of the heat-radiating fan 51 of the window-type air-conditioner 50. When operating, the heat-radiating fan 51 produces airflows to rotate the rotor 11 of the airflow pressure differential power generating assembly 10. Similarly, the induction generator 12 connected to the rotor 11 via the link 14 is driven by the rotating rotor 11 to generate electric current, which is stored in the power storage units 21 for use later.

FIG. 5 shows a fourth application of the removable power storage device of the present invention. In the fourth application, the airflow pressure differential power generating assembly 10 of the removable power storage device of the present invention is installed on a motorcycle 60. As it is known, airflow pressure differential exists at different areas of a running motorcycle due to air resistance. That is, when a motorcycle is moving, airflows are created surrounding the motorcycle. Therefore, the airflow pressure differential power generating assembly 10 can be installed, for example, on a spoiler 61 of the motorcycle 60. Surrounding air being disturbed by the spoiler 61 would drive the induction generator 12 of the airflow pressure differential power generating assembly 10 to generate electric current, which is stored in the power storage units 21 for use later. A net-like protective cover 27 can be mounted on the spoiler 61 outside the airflow pressure differential power generating assembly 10 to protect the rotor 11 against damage due to collision with external objects.

According to the above applications, the removable power storage device of the present invention is advantageous in that it can be installed at any site at where airflows can be produced, so as to generate and store electric power; and that the power storage units can be quickly removed from the main body of the power storage assembly and carried to any place requiring electric power. In addition, the removable power storage device of the present invention is modularized to enable easy maintenance, repair, and replacement thereof.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A removable power storage device comprising:
at least one airflow pressure differential power generating assembly including a rotor and an induction generator connected to the rotor; the rotor being driven to rotate by energy created by an airflow pressure differential, and thereby bringing the induction generator connected thereto to generate and output electric current; and
a power storage assembly including a main body, a control circuit unit, and at least one power storage unit; the control circuit unit receiving and processing the electric current output by the induction generator and then outputting stable charging current and providing overload protection to the power storage unit; the power storage unit being removably installed in the main body, and having an input terminal connected to a charging current output terminal of the control circuit unit for storing electric power output by the control circuit unit and an output terminal, via which the power stored in the power storage unit is supplied for use.

2. The removable power storage device as claimed in claim 1, wherein the main body includes a plurality of compartments, and the control circuit unit and the power storage unit being independently removably installed in the compartments.

3. The removable power storage device as claimed in claim 1, wherein the control circuit unit is integrated with the main body to form an integral body.

4. The removable power storage device as claimed in claim 1, wherein a net-like protective cover is mounted to an outer side of the airflow pressure differential power generating assembly.
